(19) United States
(12) Patent Application Publication
(10) Pub. No.: US 2014/0183206 A1
(43) Pub. Date: Jul. 3, 2014

(54) PRODUCT TRAY FOR VENDING MACHINE

(71) Applicant: HON HAI PRECISION INDUSTRY CO., LTD., New Taipei (TW)

(72) Inventors: YUN-LUNG CHEN, New Taipei (TW); CHIN-WEN YEH, New Taipei (TW)

(73) Assignee: HON HAI PRECISION INDUSTRY CO., LTD., New Taipei (TW)

(21) Appl. No.: 14/011,928

(22) Filed: Aug. 28, 2013

(30) Foreign Application Priority Data
Dec. 29, 2012 (CN) 2012105888405

(51) Int. Cl. G07F 11/58

(52) U.S. Cl. CPC G07F 11/58
USPC 221/85

(57) ABSTRACT

A product tray includes a tray body and two rotating device. The tray body includes a bottom panel and two mounting portions extending from the bottom panel. Each of the rotating devices includes a pivot shaft mounted to one of the two mounting portions, a roller, and an engaging member. The pivot shaft defines an engaging slot. The roller includes a roller body and a flange extending from the roller body. The roller body defines a pivot hole. The flange defines a cutout. The pivot shaft is received in the pivot hole. The engaging member is placed in the flange via the cutout and to engage in the engaging slot to prevent the roller body from moving along a direction substantially parallel to the pivot shaft.

### BACKGROUND

1. Technical Field

The present disclosure generally relates to a product tray of a vending machine.

2. Description of Related Art

Vending machines allow customers to buy product twenty four hours a day. The vending machine includes a plurality of product trays for receiving merchandise. The product trays are received in an enclosure. The product tray includes a plurality of rollers mounted to the bottom portion of the product tray. However, the roller includes a nut, a gasket, a bolt, and so on. It is inconvenient to assemble the roller.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a product tray of a vending machine.

FIG. 2 is an assembled view of the product tray of FIG. 1.

FIG. 3 is an enlarged and isometric view of portion III of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

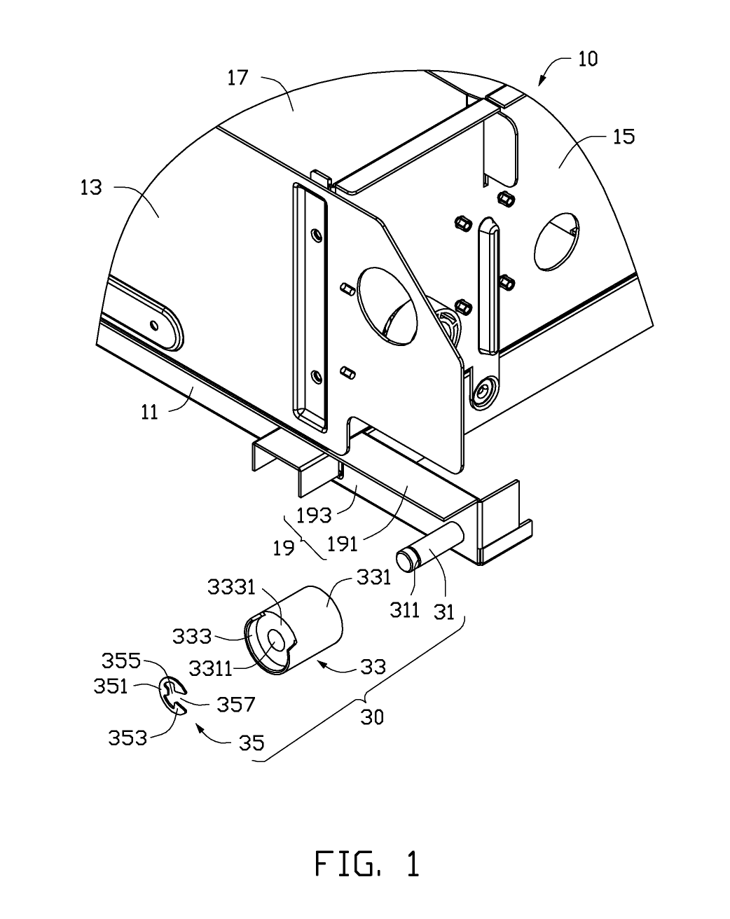

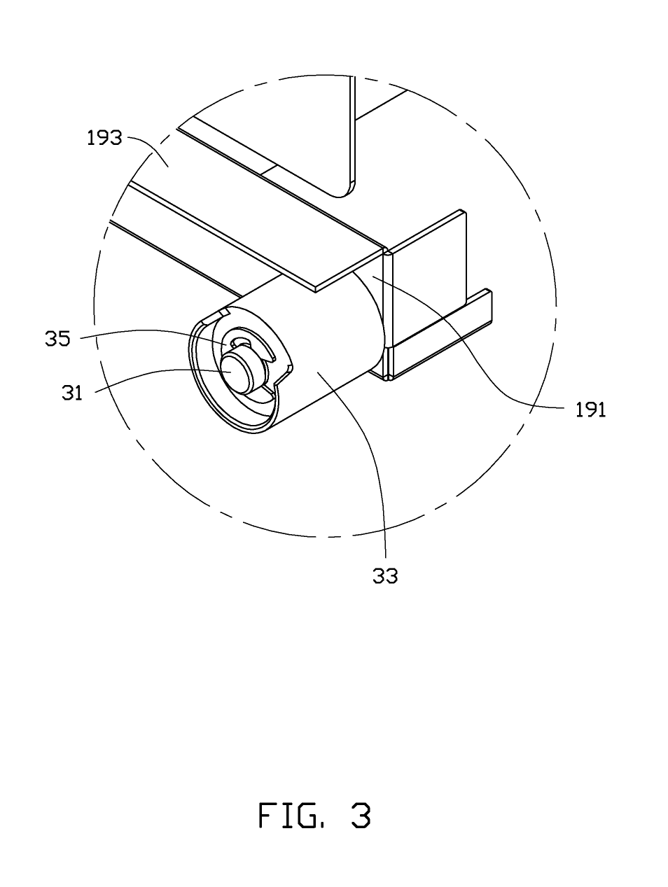

FIGS. 1 and 3 show that a product tray of a vending machine, according to one embodiment, includes a tray body 10 and two rotating devices 30 (shown in FIG. 3) mounted to the tray body 10.

The tray body 10 includes a bottom panel 11, a plurality of separating panels 13 mounted on the bottom panel 11, and a front panel 15 connected to the separating panels 13 and the bottom panel 11. The separating panels 13 are substantially parallel to each other. A channel 17 is defined between two adjacent separating panels 13. The front panel 15 is substantially perpendicular to the bottom panel 11 and the separating panels 13.

The tray body 10 further includes two mounting portions 19 extending forward from the bottom panel 11. Each mounting portion 19 includes a mounting tab 191 extending from the bottom panel 11 and an extending tab 193 extending from the bottom panel 11. The extending tab 193 is substantially perpendicular to the mounting tab 191. The mounting tab 191 is substantially perpendicular to the bottom panel 11.

The rotating device 30 includes a pivot shaft 31 secured to the mounting tab 191, a roller 33, and an engaging member 35. The pivot shaft 31 is substantially perpendicular to the mounting tab 191. In one embodiment, the pivot shaft 31 is riveted to the mounting tab 191. The pivot shaft 31 defines an engaging slot 311 in the free end of the pivot shaft 31.

The roller 33 includes a roller body 331 and a flange 333 extending from the roller body 331. The flange 333 is arc-shaped. The flange 333 defines a cutout 3331. The roller body 331 defines a pivot hole 3311 corresponding to the pivot shaft 31.

The engaging member 35 includes a connecting portion 351 and two engaging portions 353 extending from the connecting portion 351. The connecting portion 351 and the two engaging portions 353 surround a receiving opening 355. The engaging member 35 defines an input opening 357 communicating with the receiving opening 355. The input opening 357 is defined between the two engaging portions 353.

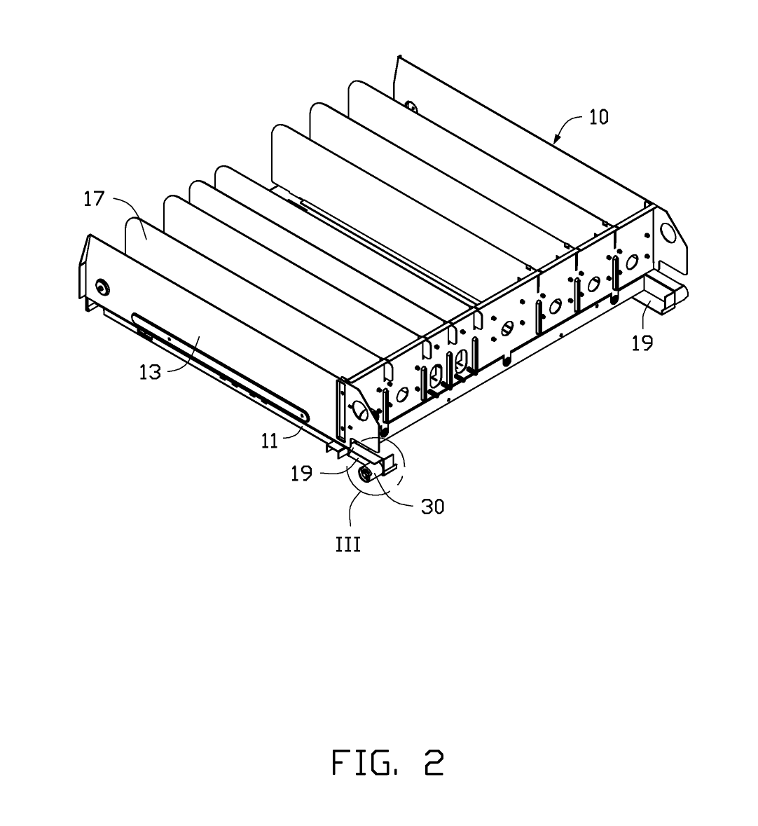

FIGS. 2 and 3 show that in assembly, the pivot hole 3311 of the roller body 331 is aligned with the pivot shaft 31. The roller body 331 moves toward the pivot shaft 31 to enable the pivot shaft 31 to pass through the pivot hole 3311. At this time, the engaging slot 311 of the pivot shaft 31 is exposed out of the roller body 331. The engaging member 35 is placed in the flange 333 via the cutout 3331 to enable the input opening 357 to be aligned with the engaging slot 311. The engaging member 35 moves toward the pivot shaft 31 to enable the two engaging portions 353 to engage in the engaging slot 311. At this time, the pivot shaft 31 is received in the receiving opening 355.

The rotating device 30 has a simple structure and can be easily assembled together.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A product tray comprising:
a tray body, the tray body comprises a bottom panel and two mounting portions extending from the bottom panel; and
two rotating devices, each of the rotating devices comprises a pivot shaft mounted to one of the two mounting portions, a roller, and an engaging member; the pivot shaft defines an engaging slot; the roller comprises a roller body and a flange extending from the roller body; the roller body defines a pivot hole; the flange defines a cutout; the pivot shaft is received in the pivot hole; and the engaging member is configured to be placed in the flange via the cutout and to engage in the engaging slot to prevent the roller body from moving along a direction substantially parallel to the pivot shaft.

2. The product tray of claim 1, wherein the engaging member comprises a connecting portion and two engaging portions extending from the connecting portion; a receiving opening is surrounded by the connecting portion and the two engaging portions; the engaging member defines an input opening communicating with the receiving opening; the input opening is defined between the two engaging portions; and the two engaging portions are engaged in the engaging slot.

3. The product tray of claim 1, wherein the flange is arc-shaped.

4. The product tray of claim 1, wherein each of the two mounting portions comprises a mounting tab extending from the bottom panel; and the mounting tab is substantially perpendicular to the bottom panel; and the pivot shaft is secured to the mounting tab.

5. The product tray of claim 4, wherein the pivot shaft is substantially perpendicular to the mounting tab.

6. The product tray of claim 4, wherein each of the two mounting portions further comprises an extending tab extending from the mounting tab and substantially perpendicular to the mounting tab.

7. The product tray of claim 1, wherein the tray body further comprises a plurality of separating panels mounted on the bottom panel and substantially perpendicular to the bottom panel.

8. The product tray of claim 7, wherein the tray body further comprises a front panel connected to the plurality of separating panels, and the front panel is substantially perpendicular to the bottom panel.

9. The product tray of claim 8, wherein the plurality of separating panels are substantially parallel to each other and are substantially perpendicular to the front panel.

10. A product tray comprising:
a tray body, the tray body comprises a bottom panel, a plurality of separating panels mounted on the bottom panel; and two mounting portions extending from the bottom panel; The plurality of separating panels are substantially parallel to each other; a channel is defined two adjacent separating panel of the plurality of separating panels; and
two rotating devices mounted to the two mounting portions, each of the rotating device comprises a pivot shaft mounted to one of the two mounting portions, a roller, and an engaging member; the pivot shaft is substantially perpendicular to the plurality of separating panels; the pivot shaft defines an engaging slot; the roller comprises a roller body and a flange extending from the roller body; the roller body defines a pivot hole; the flange defines a cutout; the pivot shaft is received in the pivot hole; and the engaging member is configured to be placed in the flange via the cutout and to engage in the engaging slot to prevent the roller body from moving along a direction substantially perpendicular to the plurality of separating panels.

11. The product tray of claim 10, wherein the engaging member comprises a connecting portion and two engaging portions extending from the connecting portion; a receiving opening is surrounded by the connecting portion and the two engaging portions; the engaging member defines an input opening communicating with the receiving opening; the input opening is defined between the two engaging portions; and the two engaging portions are engaged in the engaging slot.

12. The product tray of claim 10, wherein the flange is arc-shaped.

13. The product tray of claim 10, wherein each of the two mounting portions comprises a mounting tab extending from the bottom panel; and the mounting tab is substantially perpendicular to the bottom panel; and the pivot shaft is secured to the mounting tab.

14. The product tray of claim 13, wherein the pivot shaft is substantially perpendicular to the mounting tab.

15. The product tray of claim 13, wherein each of the two mounting portions further comprises an extending tab extending from the mounting tab and substantially perpendicular to the mounting tab.

16. The product tray of claim 10, wherein the plurality of separating panels is substantially perpendicular to the bottom panel.

17. The product tray of claim 16, wherein the tray body further comprises a front panel connected to the plurality of separating panels, and the front panel is substantially perpendicular to the bottom panel.

18. The product tray of claim 17, wherein the plurality of separating panels are substantially perpendicular to the front panel.
